(19) United States
(12) Patent Application Publication
(10) Pub. No.: US 2007/0239527 A1
(43) Pub. Date: Oct. 11, 2007

(54) Network-based advertising trading platform and method

(75) Inventors: Ali Nazer, Mount Albert (CA); David William Dowhan, Walnut Creek, CA (US)

Correspondence Address: Raj Abhyanker, LLP;c/o PortfolioIP, P.O. Box 52050, Minneapolis, MN, 55402, US

(73) Assignee: Adteractive, Inc.

(21) Appl. No.: 11/377,966

(22) Filed: Mar. 17, 2006

(51) Int. Cl. G06Q 30/00

(52) U.S. Cl. 705/14

(57) ABSTRACT

A network-based advertising trading platform and method is disclosed. In one embodiment, a method determines a subset of content data that is associated with a geographical marker in a first data of a user, applies an algorithm using the first data to generate a content data hierarchy, and presents an additional transaction opportunity to the user based on a selected content data from the content data hierarchy using at least one preference database. The method may also include presenting the additional transaction opportunity based on an analysis of the first data of the user, and automatically accessing a second data of the user when a trigger data associated with the selected content data is initiated. The method may further include filtering the user, reshuffling the content data hierarchy, and generating a simulation of the financial profitability modeling.

### FIELD OF TECHNOLOGY

This disclosure relates generally to the technical fields of software and/or hardware technology and, in one example embodiment, to a network-based advertising trading platform and method.

### BACKGROUND

An advertisement may be displayed on a website. To put the advertisement on the website, an advertiser (e.g., Netflix®, Blockbuster®, etc.) may pay a proprietor of the website (e.g., Amazon®, Barnes & Nobles®, etc.) a fee to buy a reserve space (e.g., an area on a confirmation page after purchasing a good/service where the advertisement can be placed) on the website. The fee may go up when traffic of the website becomes heavy and/or a demand for the reserve space is high, thereby resulting in a seller's market for the advertisement. On the other hand, a buyer's market may be formed when traffic of the website is light and/or the demand for the reserve space is low.

Once the advertiser secures the reserve space, the advertiser may try to attract a client by providing an incentive. The incentive may be displayed along with the advertisement when the client uses the website to purchase a good and/or a service. The client, enticed by the incentive (e.g., that may be in a form of discount to the good/service being purchased and/or an offering of another good/service), may be lured into purchasing the good/service being advertised.

In order to purchase the good/service on the advertisement, the client may have to reenter information (e.g., a name, an address, a credit card number, etc.). For example, the client may have to physically search for a credit card, enter the credit information, enter billing address information, and/or verification information, etc. This inconvenience may end up discouraging the client from purchasing the good/service offered by the advertiser. In addition, the advertiser may have to spend time and/or energy to find the website that meets an objective of the advertiser while being cost effective. Moreover, the proprietor of the website may want to avoid certain advertisers (e.g., for business, financial, and/or ethical reasons). In addition, the certain advertisers may wish to avoid the website for similar reasons.

### SUMMARY

A network-based advertising trading platform and method is disclosed. In one aspect, a method includes determining a subset of a plurality of content data that is associated with a geographical marker in a first data of a user, applying an algorithm (e.g., which may be based on a statistical probability analysis, a historical trending modeling, a financial probability index, and/or a targeted market index) using the first data to generate a content data hierarchy, and presenting an additional transaction opportunity to the user based on a selected content data from the content data hierarchy using at least one preference database (e.g., an advertiser preference database that indicates a set of publishers acceptable to a particular advertiser and/or a publisher preference database that indicates a set of advertisers acceptable to a particular publisher).

The method may also include presenting the additional transaction opportunity based on an analysis of the first data (e.g., non-personally identifiable data which includes a gender of the user, a geographic marker of the user, a first name of the user, a transaction amount, a payment type, and/or a membership data) of the user, and automatically accessing a second data (e.g., personally identifiable data which includes a family name of the user, a card data, a billing address, a shipping address, and/or a credit rating of the user) of the user through an escrow module when a trigger data associated with the selected content data is initiated.

The method may further include filtering the user based on one or more criteria of an advertiser module associated with the selected content data (e.g., a pre-existing membership of the user with the advertiser module, a fraud detector, a credit rating threshold, a market boundary, and/or a return history of the user), reshuffling the content data hierarchy (e.g., based on a financial profitability modeling of a network based advertiser trading platform which considers a difference between a revenue from an advertiser and a cost per impression to a publisher as a function of conversion of the selected content data), and generating a simulation of the financial profitability modeling based on at least one parameter adjustment.

The method of claim may further include determining a visual format of the selected content data based on a look and feel module that considers one or more visual characteristics associated with a publisher module, generating a form based on an additional data request of an advertiser module associated with the selected content data that supplements the first data and the second data, and iteratively presenting a further transaction opportunity based on a multi-transaction algorithm that considers the first data, the second data, and a third data generated through a transaction associated with the selected content data. The method may be realized in a form of a machine-readable medium embodying a set of instructions that, when executed by a machine, causes the machine to perform the method or methods described in the embodiment.

In another aspect, a method may include displaying a continuity advertisement having a continuity form that requests an additional data which supplements a transaction data previously acquired by a publisher module, iteratively displaying a next advertisement having a next form that supplements the additional data and the transaction data when the continuity advertisement is successfully converted, and processing a payment based on a factor (e.g., a number of impressions of the continuity advertisement and the next advertisement) associated with the continuity advertisement and the next advertisement.

In yet another aspect, a system (e.g., which may be also based on an escrow module which communicates non-personally identifiable data of a purchaser derived from a purchase and a platform module which utilizes the non-personally identifiable data obtained from the escrow module to present an advertisement by a third party targeted to the purchaser) may include a publisher module to automatically capture a preference data of a user, and the platform module to present an additional transaction opportunity based on a selected content data (e.g., offers/advertisements, etc.) comprising at least one of the non-personally identifiable data, the personally identifiable data, an advertiser preference, and/or a publisher preference. The optimal content data of the system may be based a cookie data and/or a session data. The system may also optimize the offers based on a past conversion history of each of the optimal content data, a pay-in from an advertiser, a pay-out to a publisher, and/or a consumer demand.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a block diagram of a platform module that communicates with a publisher module through an escrow module, according to one embodiment.

FIG. 2 is an exploded view of the platform module of FIG. 1 having selection tools, filtering tools, and administration tools, according to one embodiment.

FIG. 3 is a graphical user interface of a publisher mark-up language file, a continuity confirmation mark-up language file, and a next confirmation mark-up language file, according to one embodiment.

FIG. 4 is a network diagram of any number of publishers communicating with any number of advertisers through a network based advertiser trading platform, according to one embodiment.

FIG. 5 is a graphical user interface of a publisher portal, according to one embodiment.

FIG. 6 is a graphical user interface of an advertiser portal, according to one embodiment.

FIG. 7 is a diagrammatic representation of a data processing system capable of processing a set of instructions to perform any one or more of the methodologies herein, according to one embodiment.

FIG. 8 is a table view of a database in the platform module of FIG. 1, according to one embodiment.

FIG. 9 is a process flow of presenting an additional transaction opportunity to the user based on a selected content data from the content data hierarchy using at least one preference database.

FIG. 10 is a process flow of presenting the additional transaction opportunity based on an analysis of a first data of a user, according to one embodiment.

FIG. 11 is a process flow of displaying a continuity advertisement, and iteratively displaying a next advertisement, according to one embodiment.

Other features of the present embodiments will be apparent from the accompanying drawings and from the detailed description that follows.

### DETAILED DESCRIPTION

A network-based advertising trading platform and method is disclosed. In the following description, for the purposes of explanation, numerous specific details are set forth in order to provide a thorough understanding of the various embodiments. It will be evident, however to one skilled in the art that the various embodiments may be practiced without these specific details. An example embodiment provides methods to present an additional transaction opportunity to a user based on a selected content data from a content data hierarchy (e.g., based on personal data, non-personal data, other additional data entered by the user and/or a preference database of an advertiser and/or a publisher).

In another example embodiment, a system includes a publisher module which captures a preference data of a user (e.g., non-personally identifiable data, personally identifiable data, and/or additional data furnished by the user) and a platform module to present the additional transaction opportunity based on the selected content data (e.g., a string of offers to the user) comprising a non-personally identifiable data, a personally identifiable data, an advertiser preference, and/or a publisher preference. It will be appreciated that the various embodiments discussed herein may/may not be the same embodiment, and may be grouped into various other embodiments not explicitly disclosed herein.

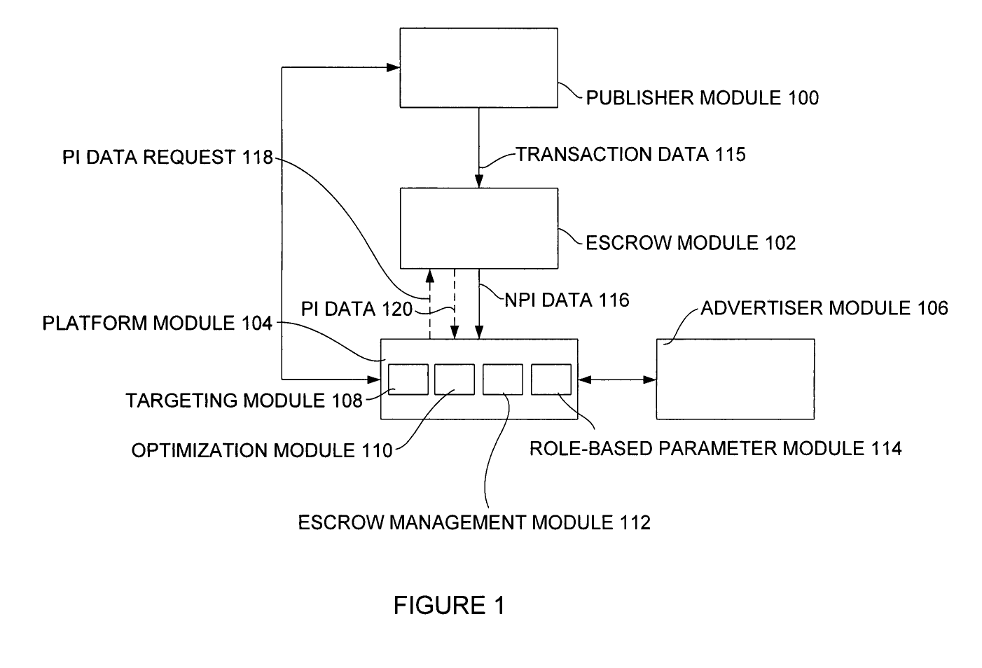

FIG. 1 is a block diagram of a platform module 104 that communicates with a publisher module 100 through an escrow module 102, according to one embodiment. The escrow module 102 (e.g., the escrow module 102 may mask certain information provided by users of the publisher module 100 from the platform module 104) may serve as a gateway between the publisher module 100 (e.g., the publisher module 100 may be a server of an organization that transacts between various parties, including an e-commerce company that exchanges goods and/or services over the Internet such as Amazon.com®, EBay®, Google®, etc.) and the platform module 104. In one embodiment, the publisher module 100 may be any website that generates a lot of traffic (e.g., many viewers, eyeballs, etc.). In an alternate embodiment, the publisher module 100 may be a commerce site like Amazon.com®, in which parties transact goods and/or services (e.g., so that personally identifiable information such as credit card information, address, location, city, etc. is pre-populated).

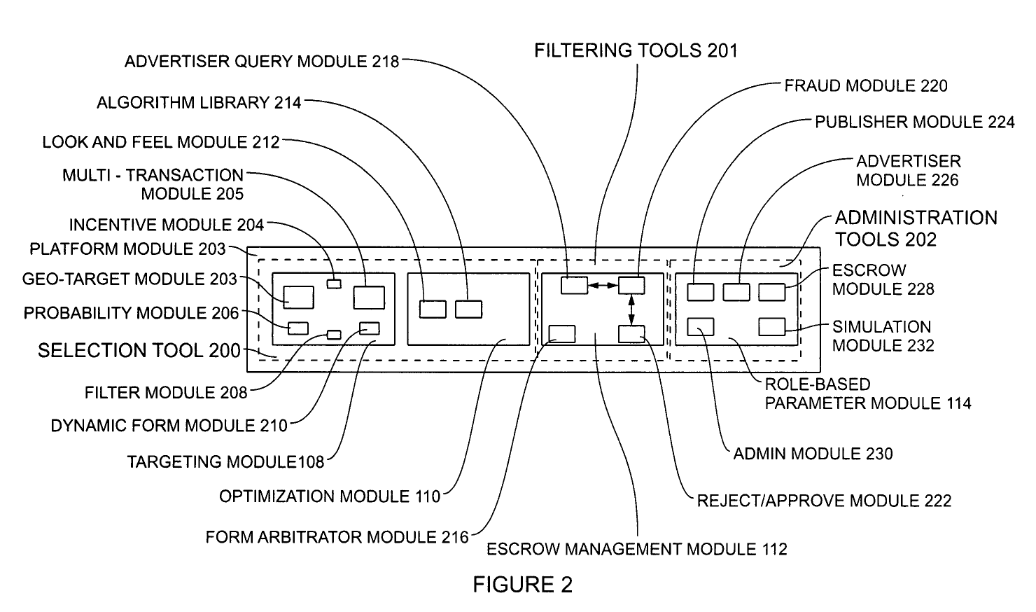

An advertiser module 106 may communicate with the platform module 104 either directly and/or through a network (e.g., an Internet network). The advertiser module 106 may belong to a company (e.g., a continuity based service, a subscription based service, etc.) which purchases advertising space on the publisher module 100 according to one embodiment. The platform module 104 is illustrated in FIG. 1 as including a targeting module 108, an optimization module 110, an escrow management module 112, and a role-based parameter module 114. The platform module 104 is best understood with reference to FIG. 2 as later will be described.

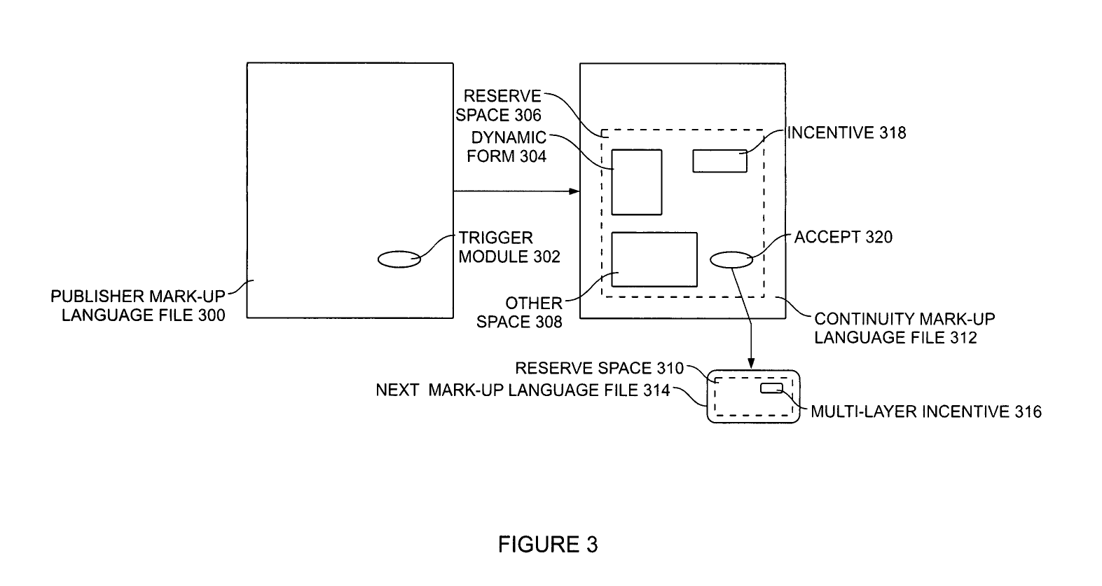

Also illustrated FIG. 1 are a set of operations (e.g., between the publisher module 100, the escrow module 102, and the platform module 104). Transaction data 115 associated with a user of the publisher module 100 is illustrated as being communicated to the escrow module 102. In one embodiment, the transaction data 115 may be communicated to the escrow module 102 when a user purchases a good and/or a service on an ecommerce website (e.g., by activating a trigger module 302 of a publisher mark-up language file 300 as illustrated in FIG. 3). Here, an algorithm to realize the embodiment may be hosted by the escrow module 102.

In another embodiment, the transaction data 115 may be utilized (e.g., without all of the transaction data 115 being revealed to the platform module 104 in order to protect the user's privacy) by the platform module 104 to present a string of offers to the user (e.g., with at least a portion of the transaction data going through the escrow module 102). Here, an algorithm to realize this embodiment may be located at the publisher module 100.

Also illustrated in FIG. 1 are a transfer of a non-personally identifiable data (NPI) 116 and a personally identifiable (PI) data 120 (e.g., together the NPI data 116 and the PI data 120 may form the transaction data 115 of FIG. 1). In one embodiment, the NPI data 116 may be transmitted to the platform module 104 when the trigger module 302 of FIG. 3 is activated by a user. The PI data 120 may be transmitted to the platform module 104 when an accept button 320 on a continuity mark-up language file 312 is activated as illustrated in FIG. 3 (e.g., the continuity mark-up language file 312 may be displayed after the trigger module 302 is initiated on the publisher mark-up language file 300 of FIG. 3, according to one embodiment).

Other operations in FIG. 1 are better clarified directly with reference to FIG. 3. FIG. 3 is a graphical user interface of the publisher mark-up language file 300 having the trigger module 302, the continuity mark-up language file 312, and a next mark-up language file 314, according to one embodiment. The publisher module 100 of FIG. 1 may create the publisher mark-up language file 300 of FIG. 3.

The publisher mark-up language file 300 may be a shopping cart prior to final approval of a purchase in an online commerce environment (e.g., on Amazon.com®), according to one embodiment. The trigger module 302 may be a confirm data (e.g., a confirm button) on the online commerce environment. When a user (e.g., of the publisher module 100 of FIG. 1) activates the trigger module 302 (e.g., by clicking on a representation of it), the continuity mark-up language file 312 (e.g., a confirmation page) may be displayed. In addition, when the user activates on the trigger module 302, the NPI data 116 may be transmitted from the escrow module 102 to the platform module 104. In another embodiment, the continuity mark-up language file 312 may be displayed based on a user's cookie data (e.g., which may provide a way for the platform module 104 to identify the user and keep track of the user's preferences) and/or a real time session data (e.g., AJAX which may enable the platform module 104 to validate multiple items entered by the user at a time).

The continuity mark-up language file 312 is illustrated as including a reserve space 306. The reserve space 306 may be advertising space purchased by the platform module 104 of FIG. 1, according to one embodiment. As such, the platform module 104 may pre-reserve space on a confirmation page (e.g., the continuity mark-up language file 312 of FIG. 3) of the publisher module 100, according to one embodiment. In one embodiment, the NPI data 116 may be displayed somewhere on the reserve space 306. For example, a gender of the user of the publisher module 100 of FIG. 1, a geographic marker of the user, a first name of the user, a transaction amount, a payment type, and a membership data may be displayed on the reserve space 306.

The reserve space 306 is illustrated as including a dynamic form 304, an incentive 318, an accept button 320, and an other space 308. The dynamic form 304 may be created (e.g., using a dynamic form module 210 of the platform module 104 as illustrated in FIG. 2) to obtain data other than the NPI data 116 and the PI data 120, according to one embodiment. For example, the dynamic form 304 may compare data used by the advertiser module 106 (e.g., of FIG. 1) for a particular advertisement being displayed in the reserve space 306 with the data available from the escrow module 102 of FIG. 1 (e.g. the transaction data 115 delivered as the NPI data 116 and as the PI data 120). Whatever additional data required by the advertiser module 106 may be prepared into the dynamic form 304, according to one embodiment. As such, the dynamic form 304 may display only data that is not obtainable (e.g., or not currently possessed) by the platform module 104.

The incentive 318 (e.g., coupon) in the reserve space 306 may be a discount for a user to either purchase products and/or services on the publisher module 100, the advertiser module 106, and/or any other product and/or service provider in exchange for the user to make a purchase of an offering (e.g., a continuity based service) being marketed in the reserve space 306. The incentive 318 of FIG. 3 may be created using an incentive module 204 of the platform module 104 as illustrated in FIG. 2. Also illustrated in the reserve space 306 of FIG. 3 is the other space 308. The other space 308 may be used to provide a second advertisement to a user in the reserve space 306 (e.g., the reserve space 306 may display any number of advertisements). In an alternate embodiment, the other space 308 may be used for a sweepstakes offering, a functionality tool (e.g., a payment calculator), an online survey (e.g., marketing survey), a blog, etc.

The reserve space 306 of FIG. 3 also includes as the accept button 320. The accept button 320 may enable a user to purchase the goods and/or services being marketed (e.g., continuity based goods and/or services) through the reserve space 306. The accept button 320 may trigger the transmission of the PI data 120 from the escrow module 102 to the platform module 104, according to one embodiment. In addition, the accept button 320 may trigger an opening (e.g., a separate page, a pop up display, a refreshed screen, etc.) of a next mark-up language file 314. The next mark-up language file 314 includes a reserve space 310 having a multi-layer incentive 316. In one embodiment, the next mark-up language file 314 is created by a multi-transaction module 205 of the platform module 104 as illustrated in FIG. 2.

The multi-transaction module 205 of FIG. 2 may iteratively present a further transaction opportunity (e.g., an optimal advertisement) based on a multi-transaction algorithm (e.g., stored in an algorithm library 214 of FIG. 2) that considers the first data (e.g., the NPI data 116), the second data (e.g., the PI data 120), and a third data (e.g., generated by inputs into the dynamic form 304 of FIG. 3 as managed by the dynamic form module 210 of FIG. 2) and that is generated through a transaction associated with the selected content data (e.g., may supplement the NPI data 116 and the PI data 120). A specific advertisement displayed in the reserve space 310 of the next mark-up language file 314 may be selected based on a user's preference, inputs, and/or a probability of transacting once again based on at least one previous transaction (e.g., in the publisher mark-up language file 300 and/or in the continuity mark-up language file 312) of a user, according to one embodiment. In alternate embodiments, any number of the next mark-up language file 314 may be created based on previous inputs received.

FIG. 2 is an exploded view of the platform module 104 of FIG. 1 having selection tools 200, filtering tools 201, and administration tools 202, according to one embodiment. The selection tools 200 (e.g., a set of functionality groupings) include a targeting module 108 and an optimization module 110. The selection tools 200 may be used to decide what type of advertisement to display to a user of the publisher module 100, according to one embodiment. The filtering tools 201 include an escrow management module 112. The administration tools 202 include a role-based parameter module 114.

The selection tools 200 include the targeting module 108 (e.g., as illustrated in FIG. 1) and the optimization module 110 (e.g., as illustrated in FIG. 1). The targeting module 108 is illustrated as having a number of modules including a geo-target module 203, an incentive module 204, a multi-transaction module 205, a probability module 206, a filter module 208, and a dynamic form module 210. The geo-target module 203 may be used to focus advertising to users in a specific geography (e.g., based on a zip code, a city, a state, a country, etc.).

The incentive module 204 may be used to offer a particular user with an incentive to transact on the publisher module 100 of FIG. 1 (e.g., an example incentive 318 is illustrated in FIG. 3). The multi-transaction module 205 may be used to create a secondary (e.g., or tertiary, quaternary, quinary, senary, etc.) advertisement based on all previous transactions within a purchase chain (e.g., within a set of acceptances leading up to the current advertisement screen). In one embodiment, any number of multiple advertisements (e.g., multiple layers) may be offered to the user.

Also illustrated in the targeting module 108 of the platform module 104 as illustrated in FIG. 2 is a probability module 206. The probability module 206 may be used to assign a statistical factor on a particular conversion rate of an advertisement (e.g., a likelihood that a user will purchase an offering on a particular type of advertisement). An advertisement with the highest likelihood of conversion may be displayed in the reserve space 306 and/or the reserve space 310 of FIG. 3 using the probability module 206. Also illustrated is the filter module 208 in FIG. 2. The filter module 208 may be used to segment and/or display a particular advertisement to a user based on quantitative and/or qualitative criteria. For example, the filter module 208 may be used to display certain advertisements to senior citizens who are concerned about health care.

The targeting module 108 also includes the dynamic form module 210. The dynamic form module 210 may create the dynamic form 304 as described with reference to FIG. 3. The dynamic form module 210 may display only certain fields that request data that is not easily retrievable by the platform module 104 from the escrow module 102 of FIG. 1, in one embodiment.

Also illustrated as part of the selection tools 200 is the optimization module 110. The optimization module 110 may be used to increase profitability by using analyses to decide what advertisement to place based on any number of algorithms and/or methods definable by a user of the platform module 104. The optimization module 110 includes a look and feel module 212 and an algorithm library 214. The look and feel module 212 may consider at least one visual characteristic (e.g., a screen color, a font size, a graphical pattern, a color scheme, a font type, etc.) associated with the publisher module 100 of FIG. 1 to adapt to the visual style of the publisher mark-up language file 300 of FIG. 3, according to one embodiment. The algorithm library 214 may be a database that includes a set of algorithms (e.g., rules) that govern how a particular operation (e.g., such as which advertisement to display in the reserve space 306) is performed. Different algorithms in the algorithm library 214 may be formed by a statistical probability calculation created using the probability module 206 as illustrated in FIG. 2. In one embodiment, a system and/or a method may include displaying a string of offers optimized by a past conversion history (e.g., of an advertiser), a pay-in from an advertiser (e.g., to a service provider offering advertisement placement services via the platform module 104), a pay-out to a publisher (by the service provider), and a consumer demand (e.g., shown by the amount of traffic flowing through the service provider).

Next, we illustrate operation of the filtering tools 201. The filtering tools 201 may be used to decide what data to display to the platform module 104, according to one embodiment. The filtering tools 201 includes the escrow management module 112 having a form arbitrator module 216, an advertiser query module 218, a fraud module 220, and a reject/approve module 222. The escrow management module 112 may be used to manage arbitration, delivery, and/or mediation between various data requests and permissions granted from data owners. The form arbitrator module 216 may be used to determine when a particular form should be displayed and created using the dynamic form module 210, according to one embodiment.

The advertiser query module 218 may be used to obtain a criteria from the advertiser module 106 (e.g., of FIG. 1) to screen out (e.g., filter) certain users (e.g., because of preexisting membership, etc.). The fraud module 220 may also be used to make sure that the user is not associated with a fraudulent payment means (e.g., a stolen credit card). The reject/approve module 222 may be used to permit and/or deny a particular purchaser from accessing an offering (e.g., a good and/or service) being marketed on the reserve space (e.g., the reserve space 306 and/or the reserve space 310 as illustrated in FIG. 3).

Also, illustrated in FIG. 2 are administration tools 202 which include the role-based parameter module 114. The administration tools 202 may be used by an operator (e.g., an administrator) of the publisher module 100, the escrow module 102, the platform module 104, and/or the advertiser module 106 to monitor performance on an advertisement and/or marketing campaign, to administer rules and/or privileges to various parties, select what types of advertisers and/or publishers to partner with, etc.

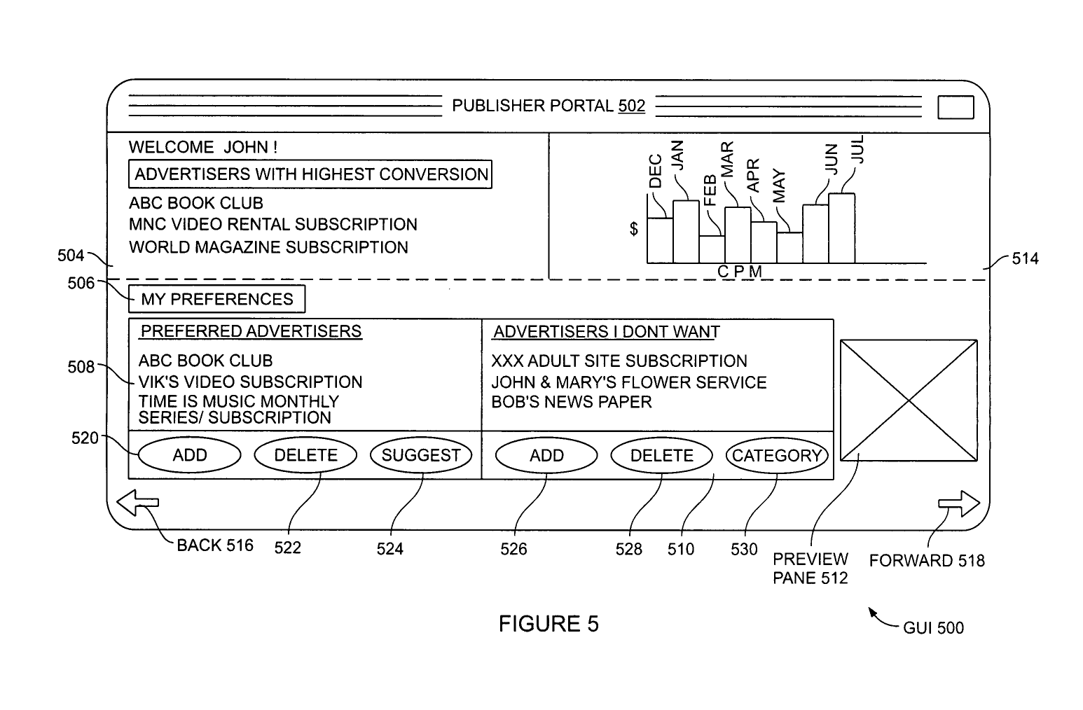

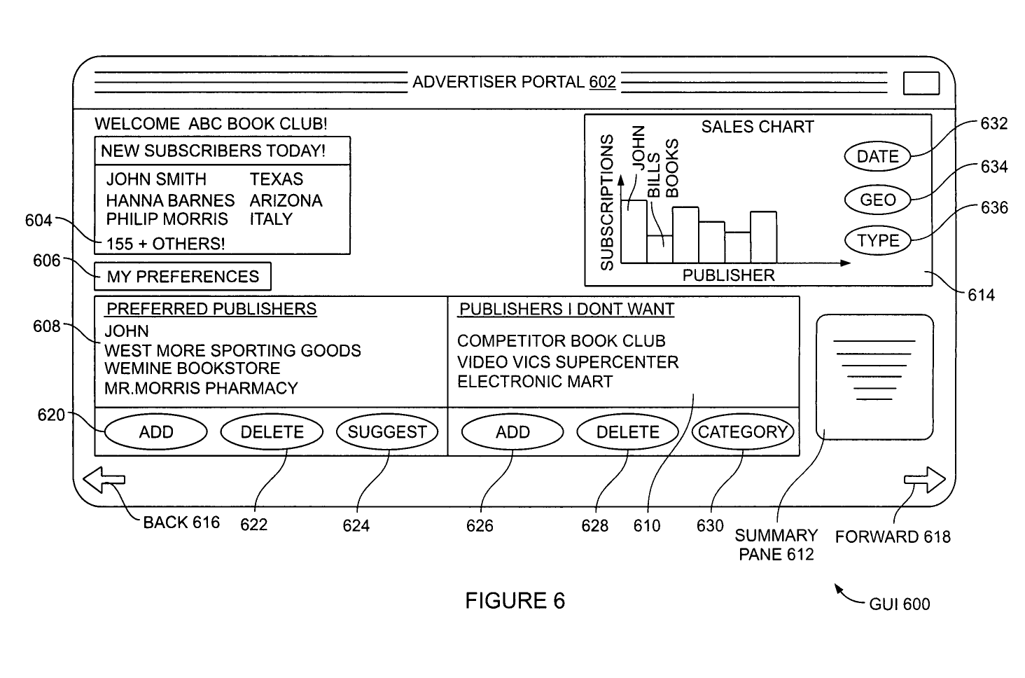

The role-based parameter module 114 includes a publisher portal module 224, an advertiser portal module 226, an escrow portal module 228, an admin module 230, and a simulation module 232. The role-based parameter module 114 may be used by various parties to select what level of access a particular advertiser, publisher, administrator, and/or other interested party has to a specific type of controlled data (e.g., PI data 120 of FIG. 1). The publisher portal module 224 may be used generate, publish, prioritize, and/or manage a publisher portal 502 as illustrated in FIG. 5. The advertiser portal module 226 may be used to generate, publish, prioritize, and/or manage an advertiser portal 602 as illustrated in FIG. 6. The escrow portal module 228 may be used to generate, publish, prioritize, and/or manage an escrow portal (not shown) that may enable an administrator of the escrow module 102 of FIG. 1 to monitor status and provide approvals to requests for the PI data 120.

Also illustrated in the role-based parameter module 114 is an admin module 230. The admin module 230 may be used by a user of the platform module 104 to maximize revenue from a specific type of advertisement, according to one embodiment. In addition, the role-based parameter module 114 includes a simulation module 232. The simulation module 232 may be used to predict and/or graphically display what revenue and/or CPM (cost per thousand impressions) stream might translate into dollars based on an adjustment of one or more parameters, according to one embodiment. The various tools illustrated herein may not be the only tools in the platform module 104. In alternative embodiments, there may be different tools and/or modules in addition to, and/or in substitute of the embodiment illustrated in FIG. 2.

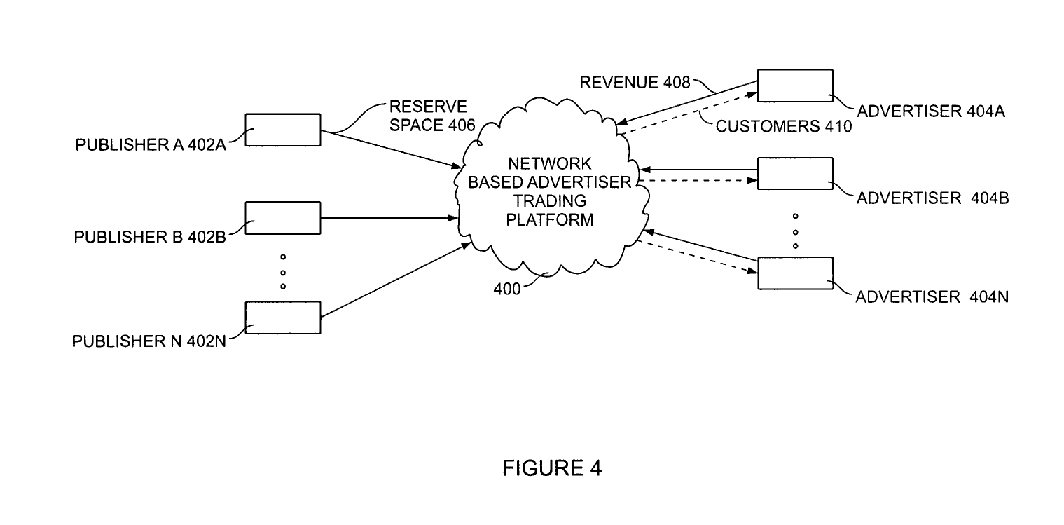

FIG. 4 is a network diagram of any number of publishers 402 communicating with any number of advertisers 404 through a network based advertiser trading platform 400, according to one embodiment. According to one embodiment, the network based advertiser trading platform 400 may be the platform module 104 of FIG. 1 to FIG. 3. Illustrated in FIG. 4 is an environment in which a plurality of publishers 402 and a plurality of advertisers 404 converge on the network based advertiser trading platform 400 to barter, trade, bid, and/or transact a marketplace of advertising services.

For example, the network based advertiser trading platform 400 may serve as an intermediary between advertisers (e.g., continuity based service providers) wishing to purchase advertising space and publishers wishing to find advertisers for unused/unsold advertising opportunities. Illustrated as an example in FIG. 4, a publisher 402A may provide a reserve space 406 (e.g., such as the reserve space 306 and/or the reserve space 310 of FIG. 3) to the network based advertiser trading platform 400. In should be noted that the reserve space 406 may be provided in a pre-transaction and/or post-transaction setting. For example, the reserve space 406 may be provided prior to a sale and/or after a sale on a publisher's website.

An advertiser 404A may provide revenue 408 to the publisher 402A. The network based advertiser trading platform 400 may create a bid/auction system so the advertiser 404A who is able and willing to pay the greatest consideration receives choice advertising opportunities. The network based advertiser trading platform 400 may earn revenues through a variety of models such a transaction based revenue model, a fixed fee model, and/or a conversion rate dependency module. The advertiser 404A may receive customers 410 (e.g., and/or clients) through the network based advertiser trading platform 400 from leads mined and/or converted through placements of advertisements on the publisher 402A. As such, the network based advertiser trading platform 400 may seek to optimize returns for all parties involved by creating an economic marketplace for which to trade advertising space. In one embodiment, the network-based advertising trading platform 400 may purchase block advertising on an offline and/or online reserve space (e.g., five pages in a magazine and/or block reserve space on Google®), and resell the available space to potential advertisers in smaller segments than the block reserve space.

FIG. 5 is a graphical user interface 500 of a publisher portal 502, according to one embodiment. The publisher portal 502 may be used by a publisher to choose which advertisers to show up on their offers. The publisher portal may also allow offers from third parties (e.g., thus selling offers from the third parties at a fee rather than selling the publisher's own offers). The publisher portal 502 may further allow the publisher to select and/or filter out the advertisers and their offers. Moreover, a particular type of advertisement (e.g., gambling, pornography, etc.) may be filtered out rather than an individual advertiser as a whole. Also the publisher portal 502 may offer an incentive (e.g., coupon, etc.) on an up-sell offer creating a coupon-incentive market place where a consumer may be allowed to use the incentive in a coupon-incentive market place (e.g., made up of a consortia of companies participating in the coupon-incentive market place).

In FIG. 5, the publisher portal 502 includes advertisers with highest conversion 504, my preferences 506, and a CPM 514 (cost per thousand impressions). The advertisers with highest conversion 504 may display one or more of the advertisers 404 (e.g., that may have been effective in using the reserve space 306 and the reserve space 310). For example, in FIG. 5, ABC Book Club is listed as the advertisers 404 which has converted its advertisement into revenue better than any other advertisers 404 (e.g., successfully luring a user to purchase the good and/or the service displayed in the advertisement).

The my preferences 506 may include preferred advertisers 508, ‘Advertisers I Don't Want’ 510, a preview pane 512, a back button 516, and a forward button 518. The preferred advertisers 508 may be added (e.g., using an add button 520) and/or deleted (e.g., using a delete button 522) by an administrator of the publisher portal 502. Also, the administrator may use a suggest button 524 to list one or more of the preferred advertisers 508. The ‘Advertisers I Don't Want’ 510 may be added (e.g., using the add button 526) and/or deleted (e.g., using the delete button 528). Also, the administrator may use a category button 530 to add and/or delete a whole category of the advertisers that the administrator does not want to be associated with the publisher (e.g., the publishers 402).

The preview pane 512 may display a miniaturized view of advertisers listed on the my preferences 506. Once the administrator finishes a viewing of a particular advertiser, a next advertiser may be viewed through the forward button 518. The back button 516 may be used to return to the particular advertiser. The CPM 514 may be used in marketing as a benchmark to calculate the relative cost of an advertising campaign or an advertisement message in a given medium. Rather than an absolute cost, the CPM 514 may estimate the cost per 1000 views of the advertisement (e.g., calculated by total cost*1000/total audience).

FIG. 6 is a graphical user interface 600 of an advertiser portal 602, according to one embodiment. The advertiser portal 602 may be used by an advertiser to select which publishers to promote the advertiser's offers. The advertiser portal 602 may also allow the advertiser to filter publishers and other advertisers (e.g., thereby refusing to share the same screen with the advertiser's competitors). The advertiser may reject a cross-sell (e.g., to suggest that customers buy additional, complementary, or related accessories or products during or just after their primary purchase) when a competitor follow before or after the advertiser (e.g., which in turn allows the advertiser to decide what types of other advertisers can be allowed in a chain of offers preceding and/or following the advertiser's own offer). The advertiser may adjust offers based on what other advertisers are doing with their continuity-based services or products (e.g., health and/or beauty magazines, entertainment, goods and/or services by companies based on subscription based models, etc.).

In another embodiment, the advertiser may adjust their pay-ins based on real time economics shown on a report prepared by a network-based advertising optimization service provider (e.g., hosting the platform module 104) where the report may cover how much money the advertiser spent, how many advertisements have been shown, how many clicks received, and/or how many actual sales took place. The advertiser may receive recommendations for other publishers that may give the advertiser more impressions, click-through rate, and/or conversion rate. The cost of acquiring the other publishers may be dependent on a market rate (e.g., based on cost per acquisition (CPA) and/or cost per thousand impression (CPM)).

In FIG. 6, the advertiser portal 602 includes ‘New Subscribers Today’ 604, my preferences 606, and a sales chart 614. The ‘New Subscribers Today’ 604 may display one or more of new subscribers (e.g., with a geographical information) that has transacted the good and/or the service offered by the advertisers 404. For example, in FIG. 6, John Smith from Texas has just subscribed to the good and/or the service offered by ABC Book Club.

The my preferences 606 may include preferred publishers 608, ‘Publishers I Don't Want’ 610, a summary pane 612, a back button 616, and a forward button 618. The preferred publishers 608 may be added (e.g., using an add button 620) and/or deleted (e.g., using a delete button 622) by an administrator of the advertiser portal 602. Also, the administrator may use a suggest button 624 to list one or more of the preferred publishers 608. The ‘Publishers I Don't Want’ may be added (e.g., using the add button 626) and/or deleted (e.g., using the delete button 628). Also, the administrator may use a category button 630 to add and/or delete a whole category of publishers that the administrator does not want.

The summary pane 612 may display a list of summary that may be used by the advertiser 404 of FIG. 4 in setting up a business strategy (e.g., such as the summary of the sales chart 614 listing elements effective in securing new subscribers). The administrator may toggle back and forth by using the back button 616 and the forward button 618, respectively. The sales chart 614 displays a chart showing the publishers 402 of FIG. 4 versus subscriptions (e.g., which shows a number of the subscriptions brought by a particular publisher), a date button 632, a geo button 634, and a type button 636. The sales chart 614 may also be displayed based on a time (e.g., by depressing the date button 632), a geography (e.g., by depressing the geo button 634), and/or a type of the publishers 402 of FIG. 4 (e.g., by depressing the type button 636).

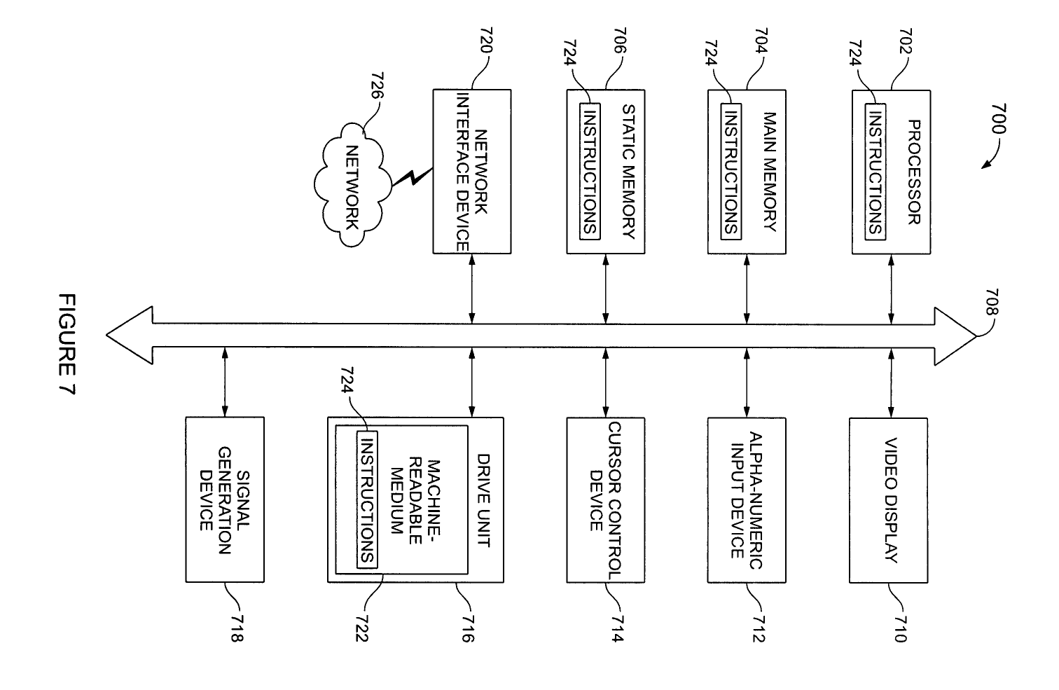

FIG. 7 is a diagrammatic representation of a data processing system capable of processing a set of instructions to perform any one or more of the methodologies herein, according to one embodiment. FIG. 7 shows a diagrammatic representation of machine in the example form of a computer system 700 within which a set of instructions, for causing the machine to perform any one or more of the methodologies discussed herein, may be executed. In various embodiments, the machine operates as a standalone device and/or may be connected (e.g., networked) to other machines.

In a networked deployment, the machine may operate in the capacity of a server and/or a client machine in server-client network environment, and/or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 700 includes a processor 702 (e.g., a central processing unit (CPU) a graphics processing unit (GPU) and/or both), a main memory 704 and a static memory 706, which communicate with each other via a bus 708. The computer system 700 may further include a video display unit 710 (e.g., a liquid crystal display (LCD) and/or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions 724 (e.g., software) embodying any one or more of the methodologies and/or functions described herein. The instructions 724 may also reside, completely and/or at least partially, within the main memory 704 and/or within the processor 702 during execution thereof by the computer system 700, the main memory 704 and the processor 702 also constituting machine-readable media.

The instructions 724 may further be transmitted and/or received over a network 726 via the network interface device 720. While the machine-readable medium 722 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

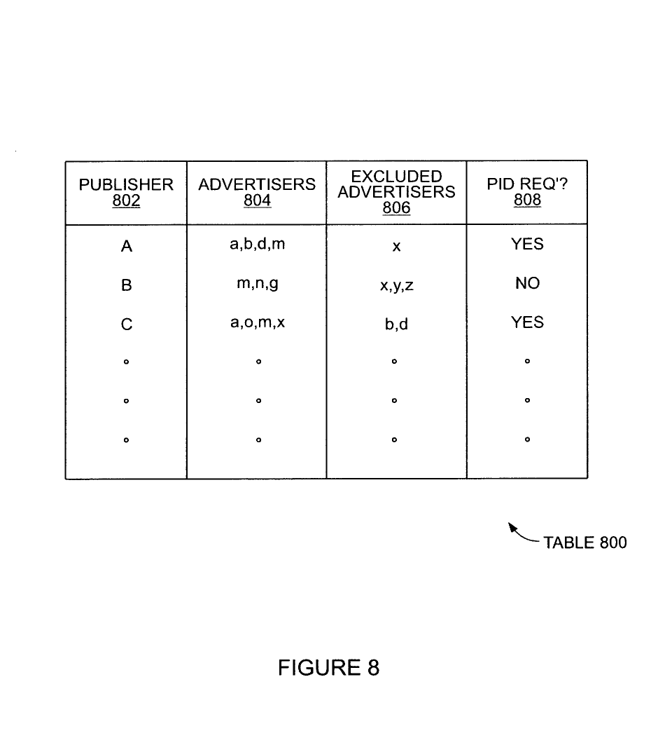

FIG. 8 is a table view of a database in the platform module 104 of FIG. 1, according to one embodiment. In FIG. 8, the table 800 displays a publisher 802, advertisers 804, excluded advertisers 806, and PI data received 808 (PI DATA RVD′?). The publisher 802 may list one or more of publishers retained by the platform module 104. The advertisers 804 may display each and every advertiser which may display its advertisement on a particular publisher module. For example, the advertisers a, b, d, and m are shown to have purchased/used a reserve space provided by the publisher A.

The excluded advertisers 806 may list the each and every advertiser which is screened out by the publisher module 100 via the publisher portal 502 for a number of reasons (e.g., such as business, financial, and/or ethical reasons). The PI data received 808 may display a receipt of the PI data 120 from the escrow module 102 upon a request (e.g., using a PID request 118) of the platform module 104.

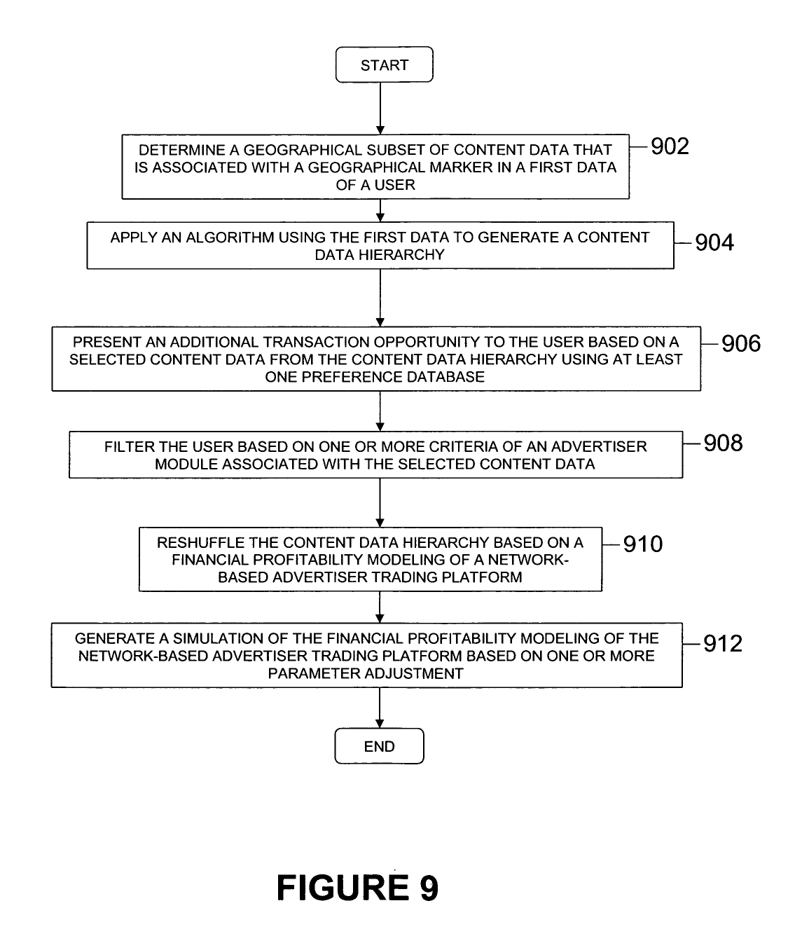

FIG. 9 is a process flow of presenting an additional transaction opportunity to the user based on a selected content data from the content data hierarchy using at least one preference database. In operation 902, presenting the additional transaction opportunity may use a subset of a plurality of content data that is associated with a geographical marker in a first data of a user. In addition, an algorithm (e.g., based on a statistical probability analysis, a historical trending modeling, a financial probability index, and a targeted market index, etc.) may be used to present the additional transaction opportunity using the first data to generate the content data hierarchy. Moreover, in operation 906, the presenting an additional transaction opportunity to the user based on a selected content data from the content data hierarchy may be possible by using at least one preference database (e.g., which may include an advertiser preference database that indicates a set of publishers acceptable to a particular advertiser, and/or a publisher preference database that indicates a set of advertisers acceptable to a particular publisher).

In operation 908, the user may be filtered (e.g., screened out) based on at least one criteria (e.g., a pre-existing membership of the user with the advertiser module 106 of FIG. 1, a fraud detector, a credit rating threshold, a market boundary, and a return history of the user) of the advertiser module 106 associated with the selected content data. In operation 910, the content data hierarchy may be reshuffled based on the financial profitability modeling (e.g., which may consider a difference between revenue from an advertiser and a cost per impression to a publisher as a function of conversion of the selected content data) of the network based advertiser trading platform 400 of FIG. 4. A simulation of the financial profitability modeling of the network-based advertiser platform based platform 400 may be generated in operation 912 based on at least one parameter adjustment.

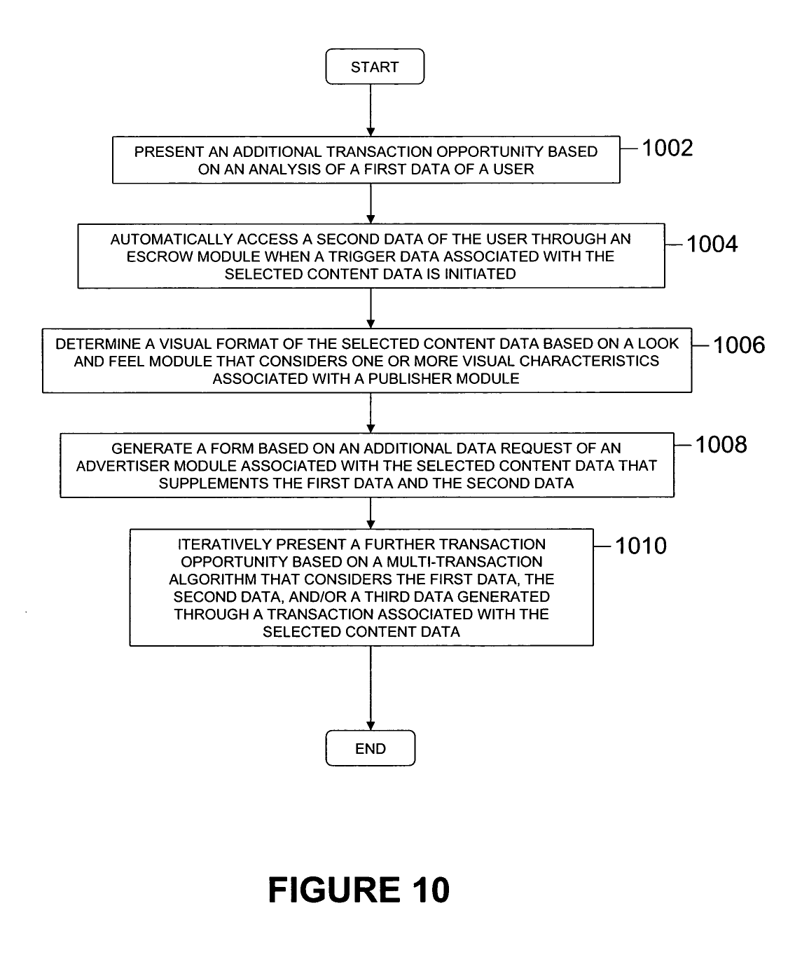

FIG. 10 is a process flow of presenting the additional transaction opportunity based on an analysis of a first data of a user, according to one embodiment. In operation 1002, an additional transaction opportunity may be presented based on an analysis of the first data (e.g., the NPI data 116 of FIG. 1 such as the gender of the user, the geographic marker of the user, the first name of the user, the transaction amount, the payment type, and the membership data, etc.) of the user. A second data (e.g., the PI data 120 of FIG. 1 such as the family name of the user, the card data, the billing address, the shipping address, and the credit rating of the user, etc.) may be automatically accessed in operation 1004 through the escrow module 102 of FIG. 1 when a trigger data associated with the selected content data (e.g., an optimal content data) is initiated.

In operation 1006, a visual format of the selected content data may be determined based on the look and feel module 212 of FIG. 2 that considers at least one visual characteristic (e.g., the screen color, the font size, the graphical pattern, the color scheme, the font type, etc.) associated with the publisher module 100 of FIG. 1. A form may be generated in operation 1008 based on an additional data request (e.g., displayed as a plurality of questionnaires on the form) of the advertiser module 106 of FIG. 1 associated with the selected content data that supplements the first data (e.g., the NPI data 116 of FIG. 1) and the second data (e.g., the PI data 120 of FIG. 1). In operation 1010, a further transaction opportunity may be iteratively presented based on a multi-transaction algorithm (e.g., generated by the multi-transaction module 205 of FIG. 2) that considers the first data, the second data, and a third data generated through a transaction associated with the selected content data.

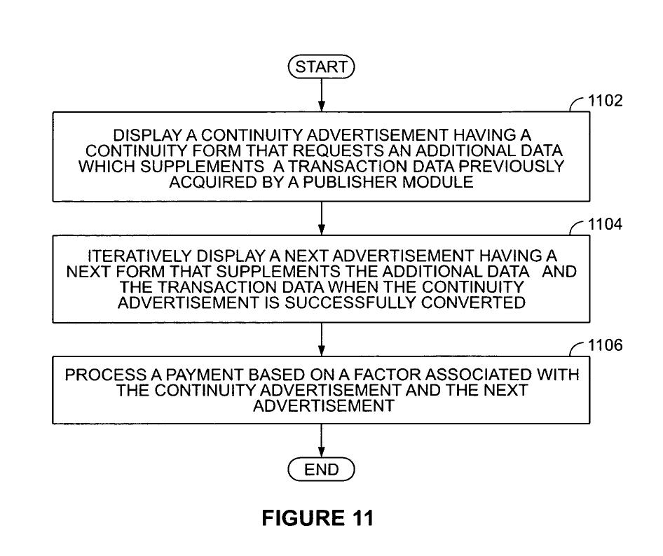

FIG. 11 is a process flow of displaying a continuity advertisement, and iteratively displaying a next advertisement, according to one embodiment. In operation 1102, the continuity advertisement having a continuity form that requests additional data which supplements a transaction data (e.g., transaction data 115) previously acquired by the publisher module 100 of FIG. 1 may be displayed. The next advertisement having a next form that supplements the additional data and the transaction data may be iteratively displayed when the continuity advertisement is successfully converted (e.g., the continuity advertisement may be converted when a transaction has been initiated through a favorable response to the continuity advertisement by the user and/or when a contract has been formed) in operation 1104. In operation 1106, a payment may be processed based on a factor associated with the continuity advertisement and the next advertisement (e.g., such as a number of impressions of the continuity advertisement and/or the next advertisement).

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the publisher module 100, the escrow module 102, the platform module 104, the advertiser module 106, the targeting module 108, the optimization module 110, the escrow management module 112, the role-based parameter module 114, the geo-target module 203, the incentive module 204, the multi-transaction module 205, the probability module 206, the filter module 208, the dynamic form module 210, the look and feel module 212, the algorithm library 214, the form arbitrator module 216, the advertiser query module 218, the fraud module 220, the reject/approve module 222, the publisher portal module 224, the advertiser portal module 226, the escrow portal module 228, the admin module 230, and the simulation module 232 may be enabled using a geo-target circuit, an incentive circuit, a multi-transaction circuit, a probability circuit, a filter circuit, a dynamic form circuit, a look and feel circuit, an algorithm library circuit, a form arbitrator circuit, an advertiser query circuit, a fraud circuit, a reject/approve circuit, a publisher circuit, an advertiser circuit, an escrow circuit, an admin circuit, and a simulation circuit based on transistors, logic gates, and electrical circuits (e.g., application specific integrated ASIC circuitry).

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method, comprising:
determining a subset of a plurality of content data that is associated with a geographic marker in a first data of a user;
applying an algorithm using the first data to generate a content data hierarchy; and
presenting an additional transaction opportunity to the user based on a selected content data from the content data hierarchy using at least one preference database.

2. The method of claim 1 wherein the at least one preference database includes:
an advertiser preference database that indicates a set of publishers acceptable to a particular advertiser; and
a publisher preference database that indicates a set of advertisers acceptable to a particular publisher,
wherein the algorithm uses at least one of a statistical probability analysis, a historical trending modeling, a financial probability index, and a targeted market index.

3. The method of claim 1, comprising:
presenting the additional transaction opportunity based on an analysis of the first data of the user; and
automatically accessing a second data of the user through an escrow module when a trigger data associated with the selected content data is initiated.

4. The method of claim 3 wherein the first data is a non-personally identifiable data which includes a gender of the user, the geographic marker of the user, a first name of the user, a transaction amount, a payment type, and a membership data, and wherein the second data is a personally identifiable data which includes a family name of the user, a card data, a billing address, a shipping address, and a credit rating of the user.

5. The method of claim 1 further comprising filtering the user based on at least one criteria of an advertiser module associated with the selected content data.

6. The method of claim 5 wherein the at least one criteria includes a pre-existing membership of the user with the advertiser module, a fraud detector, a credit rating threshold, a market boundary, and a return history of the user.

7. The method of claim 1 further comprising reshuffling the content data hierarchy based on a financial profitability modeling of a network based advertiser trading platform.

8. The method of claim 7 further comprising generating a simulation of the financial profitability modeling of the network based advertiser trading platform based on at least one parameter adjustment.

9. The method of claim 7 wherein the financial profitability modeling to consider a difference between a revenue from an advertiser and a cost per impression to a publisher as a function of conversion of the selected content data.

10. The method of claim 3 further comprising determining a visual format of the selected content data based on a look and feel module that considers at least one visual characteristic associated with a publisher module.

11. The method of claim 3 further comprising generating a form based on an additional data request of an advertiser module associated with the selected content data that supplements the first data and the second data.

12. The method of claim 3 further comprising iteratively presenting a further transaction opportunity based on a multi-transaction algorithm that considers the first data, the second data, and a third data generated through a transaction associated with the selected content data.

13. The method of claim 1 in a form of a machine-readable medium embodying a set of instructions that, when executed by a machine, causes the machine to perform the method of claim 1.

14. A method, comprising:
displaying a continuity advertisement having a continuity form that requests an additional data which supplements a transaction data previously acquired by a publisher module;
iteratively displaying a next advertisement having a next form that supplements the additional data and the transaction data when the continuity advertisement is successfully converted; and
processing a payment based on a factor associated with the continuity advertisement and the next advertisement.

15. The method of claim 14 wherein the factor is a number of impressions of the continuity advertisement and the next advertisement.

16. The method of claim 14 in a form of a machine-readable medium embodying a set of instructions that, when executed by a machine, causes the machine to perform the method of claim 14.

17. A system, comprising:
a publisher module to automatically capture a preference data of a user; and
a platform module to present an additional transaction opportunity based on a selected content data comprising at least one of a non-personally identifiable data, a personally identifiable data, an advertiser preference, and a publisher preference.

18. The system of claim 17, comprising:
an escrow module which communicates the non-personally identifiable data of a purchaser derived from a purchase; and
the platform module which utilizes the non-personally identifiable data obtained from the escrow module to present an advertisement by a third party targeted to the purchaser.

19. The system of claim 17 wherein the optimal content data to display is based on least one of a cookie data and a session data.

20. The system of claim 17 wherein the plurality of the optimal content data to display are optimized based on at least one of a past conversion history of each of the optimal content data, a pay-in from an advertiser, a pay-out to a publisher, and a consumer demand.
